(19) United States
(12) Patent Application Publication
(10) Pub. No.: US 2020/0097005 A1
(43) Pub. Date: Mar. 26, 2020

(54) OBJECT DETECTION DEVICE, OBJECT DETECTION METHOD, AND VEHICLE CONTROLLER

(71) Applicant: TOYOTA JIDOSHA KABUSHIKI KAISHA, Toyota-shi (JP)

(72) Inventors: Kota HIRANO, Tokyo-to (JP); Daisuke HASHIMOTO, Tokyo-to (JP); Satoshi TAKEYASU, Tokyo-to (JP)

(73) Assignee: TOYOTA JIDOSHA KABUSHIKI KAISHA, Toyota-shi (JP)

(21) Appl. No.: 16/582,250

(22) Filed: Sep. 25, 2019

(30) Foreign Application Priority Data
Sep. 26, 2018 (JP) 2018-180713

(51) Int. Cl. G05D 1/00; G06N 3/04; G06K 9/00

(52) U.S. Cl. CPC G05D 1/0088; G05D 2201/0213; G06K 9/00805; G06N 3/0454

(57) ABSTRACT

An object detection device includes a processor configured to: detect, by inputting a sensor signal acquired by a sensor to a neural network, an object existing around a vehicle, wherein the neural network includes an input layer, an output layer, and a plurality of layers connected between the input layer and the output layer, and wherein at least one layer of the plurality of layers includes a plurality of sub networks that include the same structure and execute arithmetic processing in parallel to each other on a signal input to the layer; and control, depending on at least either of an amount of available power or available computational resources, the number of sub networks which are used to detect the object among the plurality of sub networks in each of at least one layer.

### FIELD

The present invention relates to an object detection device and an object detection method for detecting an object, and a vehicle controller.

### BACKGROUND

A technique for detecting an object represented on an image has been studied. In recent years, in order to detect an object, a technique for improving detection accuracy using a so-called deep neural network (hereinafter, referred to simply as DNN) has been proposed. For such a DNN, a technique for reducing a number of hyper-parameters by providing sub networks having the same structure in parallel and providing a block (ResNeXt module) which sums, for an input, processing results of respective sub networks has been proposed (see, for example, Saining Xie et al., “Aggregated Residual Transformations for Deep Neural Networks”, CVPR2017, 2017).

Furthermore, a technique for reducing time required when a DNN is learned and for improving generalization of the DNN by stochastically and randomly bypassing a module in some layers when the DNN is learned, has been proposed (see, for example, Gao Huang et al., “Deep Networks with Stochastic Depth”, ECCV2016, 2016).

### SUMMARY

In the techniques described above, when object detection using a DNN is executed, an object detection process is executed using the entire network determined in advance when designing the network. Therefore, for executing the object detection process using the DNN, a certain amount of computational resources is required, and it is difficult to control a cost for arithmetic processing required for the object detection process. Meanwhile, there is an arithmetic device for which the total amount of available computational resources and the total amount of available power are limited. When the object detection process using the DNN is executed by such an arithmetic device, depending on the usage status of power by another device that receives supply of power from the same power supply as the arithmetic device or the execution status of other arithmetic processing by the arithmetic device, the amount of available power or available computational resources (hereinafter, referred to simply as available resources) for the arithmetic processing by the DNN may be insufficient. As a result, it may be difficult to complete the object detection process using the DNN within a target time.

Thus, an object of the present invention is to provide an object detection device that can complete the object detection process within a target time even when the available resources are limited.

According to one embodiment, an object detection device is provided. The object detection device includes: a processor configured to: detect, by inputting a sensor signal acquired by a sensor installed in a vehicle to a neural network, an object existing around the vehicle, wherein the neural network includes an input layer to which the sensor signal is input, an output layer that outputs a result of detection of the object, and a plurality of layers connected between the input layer and the output layer, and wherein at least one layer of the plurality of layers includes a plurality of sub networks that include the same structure and execute arithmetic processing in parallel to each other on a signal input to the layer; and control, depending on at least either of an amount of power available for detection of the object or computational resources available for detection of the object, the number of sub networks which are used when the processor detects an object among the plurality of sub networks in each of the at least one layer.

In the object detection device, the processor preferably calculates, depending on at least either of the amount of power available for detection of the object or the computational resources available for detection of the object, a target computation amount when the processor detects the object, and controls, based on the target computation amount, the number of sub networks, among the plurality of sub networks in each of the at least one layer of the neural network, which are used when the processor detects the object.

In this case, the object detection device preferably further includes a memory configured to store a table indicating a relationship between the target computation amount and a sub network, for each of the at least one layer of the neural network, which is used when the processor detects the object, among the plurality of sub networks. The processor preferably determines for each of the at least one layer of the neural network, with reference to the table and based on the target computation amount, a sub network, among the plurality of sub networks, which is used when the processor detects the object.

According to another embodiment of the present invention, an object detection method is provided. The object detection method includes: detecting, by inputting a sensor signal acquired by a sensor installed in a vehicle to a neural network, an object existing around the vehicle, wherein the neural network includes an input layer to which the sensor signal is input, an output layer that outputs a result of detection of the object, and a plurality of layers connected between the input layer and the output layer, and wherein at least one layer of the plurality of layers includes a plurality of sub networks that include the same structure and execute arithmetic processing in parallel to each other on a signal input to the layer; and controlling, depending on at least either of an amount of power available for detection of the object or computational resources available for detection of the object, the number of sub networks which are used when detecting an object among the plurality of sub networks in each of the at least one layer of the neural network.

According to still another embodiment of the present invention, a vehicle controller is provided. The vehicle controller includes: a processor configured to determine control information for the vehicle, by inputting information indicating a position of an object around a vehicle to a neural network, the position being detected by means of a sensor signal acquired by a sensor installed in the vehicle, wherein the neural network includes an input layer to which the information indicating the position of the object around the vehicle is input, an output layer that outputs the control information for the vehicle, and a plurality of layers connected between the input layer and the output layer, and wherein at least one layer of the plurality of layers includes a plurality of sub networks that include the same structure and execute arithmetic processing in parallel to each other on a signal input to the layer; and control, depending on at least either of an amount of power available for determination of the control information or computational resources available for determination of the control information, the number of sub networks which are used when the processor determines the control information for the vehicle among the plurality of sub networks in each of the at least one layer of the neural network.

The object detection device according to the present invention provides an advantageous effect that the object detection process may be completed within the target time even when the available resources are limited.

### BRIEF DESCRIPTION OF DRAWINGS

FIG. 1 is a schematic configuration diagram of a vehicle control system in which an object detection device is installed;

FIG. 2 is a hardware configuration diagram of an electronic control unit, which is an embodiment of the object detection device.

FIG. 3 is a functional block diagram of a processor of the electronic control unit relating to a vehicle control process that includes an object detection process.

FIG. 4 is a schematic configuration diagram of a variable layer included in a DNN used as a classifier.

FIG. 5 is a diagram illustrating an example of a part of a structure' of the DNN that includes a plurality of variable layers.

FIG. 6 is an operation flowchart of a classifier control process executed by a classifier control unit.

FIG. 7 is an operation flowchart of the vehicle control process that includes the object detection process.

### DESCRIPTION OF EMBODIMENTS

With reference to the drawings, an object detection device will be described below. The object detection device uses a DNN as a classifier for detecting, on an image acquired by a camera installed in a vehicle, an object existing around the vehicle. The DNN used by the object detection device includes an input layer to which the image is input, an output layer that outputs a result of detection of the object, and a plurality of hidden layers connected between the input layer and the output layer, and at least one layer of the plurality of hidden layers is configured as a variable layer including a plurality of sub networks that include the same structure and execute arithmetic processing in parallel to each other on a signal input to the hidden layer. The object detection device calculates, depending on available resources, a target computation amount for executing an object detection process once, and controls, based on the target computation amount, the number of sub networks, among the plurality of sub networks in each of at least one variable layer, which are used in the object detection process. In this manner, the object detection device can complete the object detection process within a target time even when the available resources are limited.

An example of the object detection device applied to a vehicle control system will be described below. In this example, the object detection device detects, by executing the object detection process on the image acquired by the camera installed in the vehicle, various types of objects that exist around the vehicle, for example, other vehicles, human beings, road signs or road markings, or the like, and controls the vehicle on the basis of the detection result in such a way that the vehicle performs automated driving.

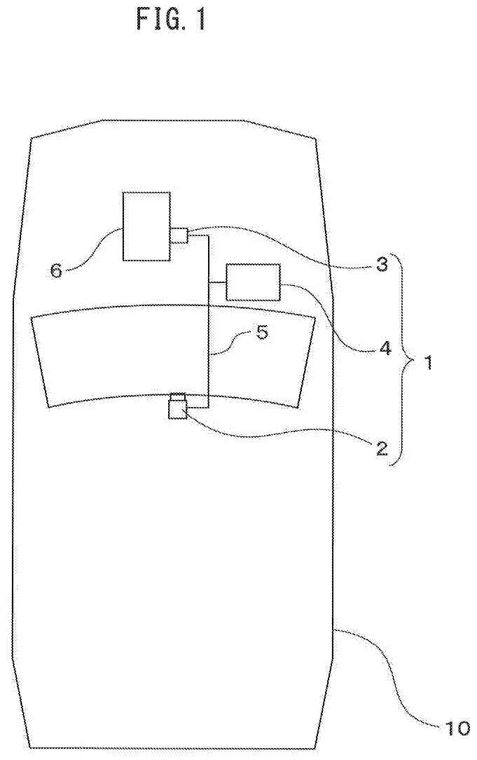

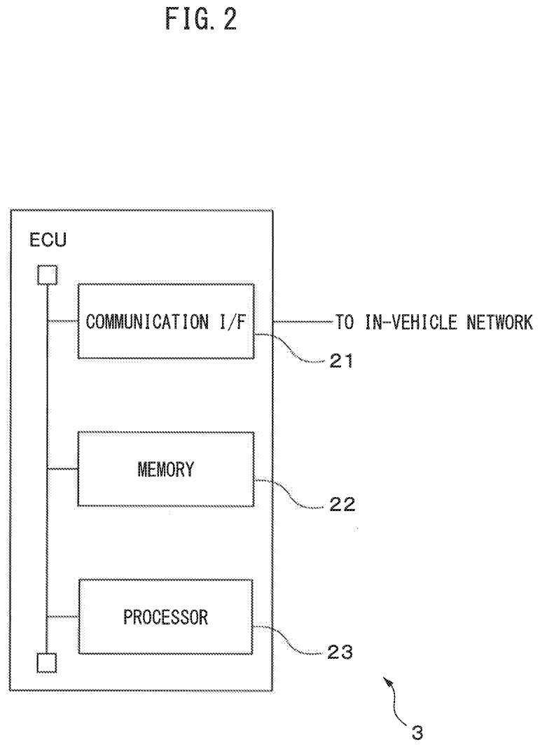

FIG. 1 is a schematic configuration diagram of the vehicle control system in which the object detection device is installed. FIG. 2 is a hardware configuration diagram of an electronic control unit, which is an embodiment of the object detection device. In the present embodiment, a vehicle control system 1 that is installed in a vehicle 10 and that controls the vehicle 10 includes a camera 2 for imaging the surroundings of the vehicle 10, an electric power sensor 3, and an electronic control unit (ECU) 4, which is an example of the object detection device. The camera 2, the electric power sensor 3, and the ECU 4 are communicatively connected via an in-vehicle network 5 conforming to a standard such as the Controller Area Network.

The camera 2 is an example of an imaging unit, which is a sensor for detecting an object present in a predetermined detection range, and includes a two-dimensional detector configured with an array of photoelectric conversion elements having sensitivity to visible light such as a CCD image sensor or a C-MOS image sensor and an imaging optical system that forms an image of a region to be imaged on the two-dimensional detector. The camera 2 is mounted in such a way that it is oriented in the front direction of the vehicle 10, for example, in a vehicle interior of the vehicle 10. The camera 2 images a region ahead of the vehicle 10 at every predetermined imaging period (for example, 1/30 seconds to 1/10 seconds) and generates an image in which the region ahead is captured. The image acquired by the camera 2 may be a color image or a gray image. Note that the image generated by the camera 2 is an example of a sensor signal.

Every time the camera 2 generates an image, the camera 2 outputs the generated image to the ECU 4 via the in-vehicle network 5.

The electric power sensor 3 is an example of a power measuring unit and measures an amount of power supplied to each device per unit time from an on-board battery 6 that supplies power to the ECU 4 at every predetermined period. The electric power sensor 3 then outputs a signal representing the measured amount of power to the ECU 4 via the in-vehicle network 5. Note that a plurality of electric power sensors 3 may be provided. Each of the plurality of electric power sensors 3 may be provided in any of devices that receive supply of power from the on-board battery 6 to measure the amount of power supplied to the device per unit time at every predetermined period, and output the signal representing the measured amount of power to the ECU 4 via the in-vehicle network 5.

The ECU 4 controls the vehicle 10. In the present embodiment, the ECU 4 controls the vehicle 10 in such a way that the vehicle 10 performs automated driving on the basis of the object detected in a time-series of images acquired by the camera 2. For this purpose, the ECU 4 includes a communication interface 21, a memory 22, and a processor 23.

The communication interface 21 is an example of a communication unit, and the communication interface 21 includes an interface circuit for connecting the ECU 4 to the in-vehicle network 5. In other words, the communication interface 21 is connected to the camera 2 and the electric power sensor 3 via the in-vehicle network 5. Every time the communication interface 21 receives an image from the camera 2, the communication interface 21 passes the received image to the processor 23. In addition, every time the communication interface 21 receives the signal representing the measured amount of power from the electric power sensor 3, the communication interface 21 passes the signal to the processor 23.

The memory 22 is an example of a storage unit, and the memory 22 includes, for example, a volatile semiconductor memory and a non-volatile semiconductor memory. The memory 22 stores various types of data used in the object detection process executed by the processor 23 of the ECU 4, such as images received from the camera 2, the amount of power measured by the electric power sensor 3, various types of parameters for specifying the classifier used in the object detection process, a reference table indicating a relationship between the available resources and a computation amount that the processor 23 can execute per second (hereinafter, referred to simply as an executable computation amount), and a reference table indicating a relationship between the target computation amount and the sub network used in the object detection process. In addition, the memory 22 may store map information.

The processor 23 is an example of a control unit, and the processor 23 includes one or more CPUs (Central Processing Unit) and a peripheral circuit thereof. The processor 23 may further include another arithmetic circuit such as an arithmetic logic unit, a numeric data processing unit, or a graphics processing unit. Every time the processor 23 receives an image from the camera 2 while the vehicle 10 is traveling, the processor 23 executes a vehicle control process that includes the object detection process on the received image. In addition, the processor 23 controls the vehicle 10 in such a way that the vehicle 10 performs automated driving on the basis of the object detected around the vehicle 10.

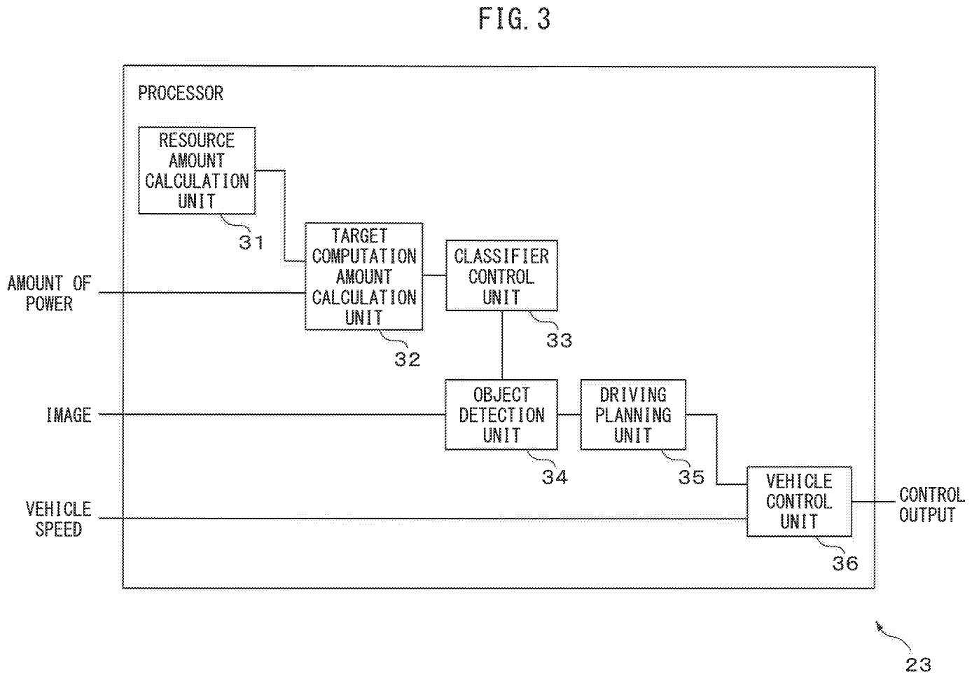

FIG. 3 is a functional block diagram of the processor 23 of the ECU 4 relating to the vehicle control process that includes the object detection process. The processor 23 includes a resource amount calculation unit 31, a target computation amount calculation unit 32, a classifier control unit 33, an object detection unit 34, a driving planning unit 35, and a vehicle control unit 36. Each of the units included in the processor 23 is a functional module achieved by, for example, a computer program operating on the processor 23. Alternatively, each of the units included in the processor 23 may be a dedicated arithmetic circuit provided in the processor 23. Furthermore, of these units included in the processor 23, the resource amount calculation unit 31, the target computation amount calculation unit 32, the classifier control unit 33, and the object detection unit 34 execute the object detection process.

The resource amount calculation unit 31 calculates, at every predetermined period, an amount of computational resources available for the object detection process of a total amount of computational resources that the processor 23 has.

For example, the resource amount calculation unit 31 calculates an idle state ratio of the processor 23 and an amount of usable memory in the memory 22 as an amount of computational resources available for the object detection process. The resource amount calculation unit 31 calculates, for example, the idle state ratio of the processor 23 by subtracting a utilization rate of the processor 23 from 1. The utilization rate of the processor 23 may be calculated, for example, as a value obtained by dividing the number of executed instructions per unit time by the number of executable instructions per unit time of the processor 23. Alternatively, the idle state ratio of the processor 23 may be a value (tutu) obtained by dividing the idle time ti per unit time to of the processor 23 by the unit time tu. In addition, the resource amount calculation unit 31 may calculate a value obtained by subtracting an amount of memory currently used in the memory 22 from the total memory capacity of the memory 22 as an amount of usable memory.

Every time the resource amount calculation unit 31 calculates the idle state ratio and the amount of usable memory, the resource amount calculation unit 31 informs the target computation amount calculation unit 32 of the idle state ratio and the amount of usable memory.

The target computation amount calculation unit 32 constitutes the network control unit together with the classifier control unit 33, and calculates a target computation amount by the object detection unit 34 for one image acquired by the camera 2 at every predetermined period, on the basis of the amount of power available for the object detection process, which is determined from the amount of power measured by the electric power sensor 3, and the amount of computational resources available for the object detection process (the idle state ratio of the processor 23 and the amount of usable memory in the memory 22). The target computation amount is determined in such a way that the object detection process may be completed within the target time (in this example, in such a way that the object detection process may be completed in a period for acquiring an image). Note that the amount of power available for the object detection process may be a value obtained by subtracting the amount of power measured by the electric power sensor 3 from the maximum value of the amount of power per unit time that the on-board battery 6 can supply. Note that the maximum value of the amount of power per unit time that the on-board battery 6 can supply is stored in advance, for example, in the memory 22.

For example, the target computation amount calculation unit 32 determines, with reference to the reference table indicating a relationship between the available resources for the object detection process (computational resources and the amount of power) and the executable computation amount, which has been stored in the memory 22 in advance, an executable computation amount per second corresponding to the available resources for the object detection process. The target computation amount calculation unit 32 then compares the executable computation amount with the computation amount per second of the object detection unit 34 in a case where all sub networks are used in the object detection process (hereinafter, referred to as maximum required computation amount). Note that the maximum required computation amount is a value obtained by multiplying the computation amount of the object detection unit 34 required for one image in the case where all sub networks are used in the object detection process by the number of images that the object detection unit 34 processes per second.

When the executable computation amount is equal to or higher than the maximum required computation amount, the target computation amount calculation unit 32 sets the target computation amount to the computation amount of the object detection unit 34 required for one image in the case where all sub networks are used in the object detection process. On the other hand, when the executable computation amount is less than the maximum required computation amount, the target computation amount calculation unit 32 sets a value obtained by dividing the executable computation amount by the number of images processed by the object detection unit 34 per second as the target computation amount.

Every time the target computation amount calculation unit 32 calculates the target computation amount, the target computation amount calculation unit 32 informs the classifier control unit 33 of the target computation amount.

The classifier control unit 33 controls at every predetermined imaging period, on the basis of the target computation amount, the number of sub networks which are used in the object detection process, among the plurality of sub networks included in the DNN that is used by the object detection unit 34 as the classifier for object detection. Note that the DNN used as the classifier is implemented in a software form by means of a computer program for object detection operating on the processor 23. However, the DNN used as the classifier may be implemented as a dedicated arithmetic circuit included in the processor 23.

In the present embodiment, the DNN used as the classifier may be a DNN having a convolutional neural network (CNN) architecture such as Single Shot MultiBox Detector, Faster R-CNN, VGG-19, or AlexNet. Alternatively, the DNN used as the classifier may be a DNN having a CNN architecture for segmentation that identifies in an input image, for each pixel in the image, an object that is likely to be represented in the pixel, such as a Fully Convolutional Network.

In other words, the DNN used as the classifier in the present embodiment includes an input layer to which an image is input, an output layer that outputs a result of object detection, and a plurality of hidden layers connected between the input layer and the output layer. The plurality of hidden layers include a convolutional layer and a pooling layer. In addition, the plurality of hidden layers may also include a fully Connected layer.

In addition, in the present embodiment, any one or more layers of the plurality of hidden layers included in the DNN are formed as a variable layer in which a plurality of sub networks that include the same structure and execute arithmetic processing in parallel to each other on a signal input to the layer. Note that, the meaning that the plurality of sub networks include the same structure indicates that the data input to respective sub networks of the plurality of sub networks are the same and that the same type of operation (for example, convolution or the like) is executed on the input data by each sub network.

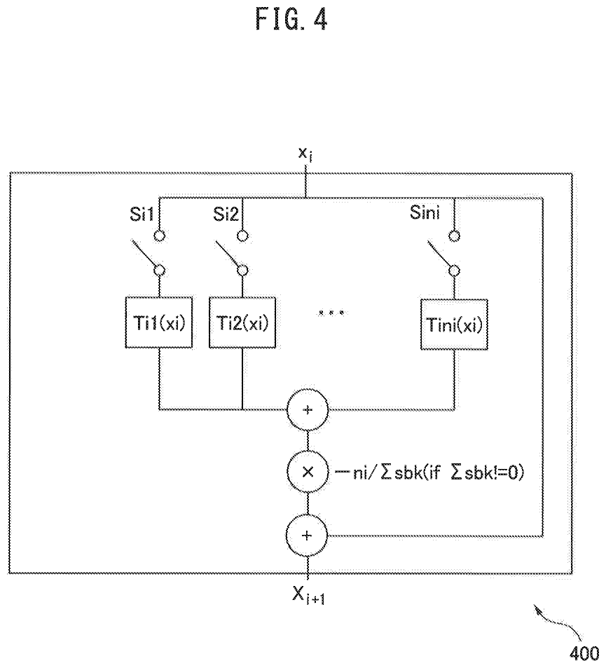

FIG. 4 is a schematic configuration diagram of a variable layer included in the DNN used as the classifier. In this example, in a variable layer 400 that is the i-th (i is an integer of one or more) layer in order from the input side of the DNN, a plurality of convolution modules Ti1(xi) to Tinᵢ(xi) (nᵢ is an integer of two or more), which execute a convolution operation on a feature map xᵢ obtained by an upstream layer of the variable layer 400, are provided in parallel to each other. These convolution modules are an example of the plurality of sub networks.

Each of the convolution modules Ti1(xi) to Tinᵢ(xi) has the same structure. Each of the convolution modules Ti1(xi) to Tinᵢ(xi) is connected between an upstream layer and a downstream layer of the variable layer 400 via switches Si1 to Sini. Each of the convolution modules Ti1(xi) to Tinᵢ(xi) has been learned in advance, on the basis of teacher data including a plurality of image, in accordance with a learning technique such as the backpropagation method. For example, when the DNN has been learned, for each of target computation amounts having a different value from each other, each switch corresponding to the target computation amount among the switches Si1 to Sini is turned on, and only a convolution module, among the convolution modules Ti1(xi) to Tinᵢ(xi), which corresponds to the switch that is turned on is connected to the DNN. Under this condition, the DNN has been learned using teacher data. In this manner, when only some convolution modules among the convolution modules Ti1(xi) to Tinᵢ(xi) are used in the object detection process, the DNN may suppress deterioration of accuracy in object detection.

In the variable layer 400, a sum of outputs of convolution modules corresponding to the switch which is turned on, among the convolution modules Ti1(xi) to Tinᵢ(xi) is calculated. Then, a total value is obtained by adding xᵢ to a value obtained by multiplying the sum by a ratio of the total number of convolution modules included in the variable layer 400 to the total number of convolution modules that has executed a convolution operation (nᵢ/τSbk, on the condition τSbk # 0, where Sbk (k=1, . . . , nᵢ) is a Boolean variable and it is 1 when the switch Sik is on and it is 0 when the switch Sik is off) and the total value is output as the feature map xᵢ₊₁. Note that, when all of the switches Si1 to Sini are turned off, the input feature map xᵢ itself is the feature map Subsequently, the feature map xᵢ₊₁ is input to the next layer.

Note that the DNN used as the classifier may include two or more variable layers as illustrated in FIG. 4.

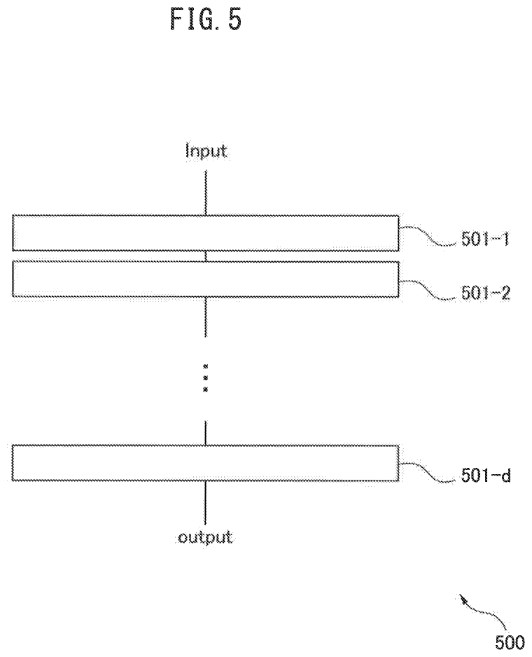

FIG. 5 is a diagram illustrating an example of a part of a structure of the DNN that includes a plurality of variable layers. As illustrated in FIG. 5, a DNN 500 includes a plurality of variable layers 501-1 to 501-d (d is an integer of two or more). Each variable layer includes two or more convolution modules. Although not illustrated in FIG. 5, another layer such as a pooling layer may be provided between two sequentially arranged variable layers. The number of convolution modules included in each of the plurality of variable layers 501-1 to 501-d may be the same or different. In addition, when the DNN 500 includes one or more fully connected layers, any one or more of the plurality of variable layers 501-1 to 501-d may be a fully connected layer. For example, the most downstream variable layer 501-d may be a fully connected layer. In this case, each of a plurality of sub networks included in the variable layer being the fully connected layer, may be configured in such a way that the sub network calculates a single output value using, as an input, all output values from a plurality of neurons included in an upstream layer. Furthermore, when a fully connected layer is a variable layer, a neuron for outputting a detection result with respect to a certain type of object to be detected may be a sub network, and it is determined based on the target computation amount whether or not the sub network is used in the object detection process. In this case, as the target a computation amount is lower, the number of types of objects to be detected decreases.

For each variable layer, the classifier control unit 33 turns on a switch, among the switches Si1 to Sins (i=1,2, . . . , d), corresponding to the sub network used depending on the target computation amount, and turns off other switches. For this purpose, for example, by referring to a reference table, stored in the memory 22 in advance, indicating a relationship between the target computation amount and a combination of switches to be turned on, the classifier control unit 33 can identify the combination of switches to be turned on, which corresponds to the target computation amount. Then, the classifier control unit 33 turns on each switch included in the identified combination and turns off other switches. In this manner, the classifier control unit 33 controls the classifier in such a way that the sub network corresponding to the target computation amount is used in the object detection process. Note that the reference table is preferably configured in such a way that, as the target computation amount is larger, the number of switches to be turned on, i.e., the number of sub networks to be used for object detection is larger. In addition, for example, when the target computation amount is a computation amount corresponding to that of the object detection unit 34 required for one image in the ease where all sub networks are used in the object detection process, the classifier control unit 33 preferably controls the number of sub networks in such a way that all sub networks are used in the object detection process. In this maimer, the processor 23 can improve accuracy in object detection as the target computation amount is higher while the computation amount required for object detection may be reduced when the target computation amount is lower. Therefore, even when it is difficult to secure computational resources available for object detection sufficiently, the processor 23 can complete the object detection process in an execution cycle while suppressing deterioration of accuracy in object detection. In other words, the processor 23 can complete the object detection process within the target time.

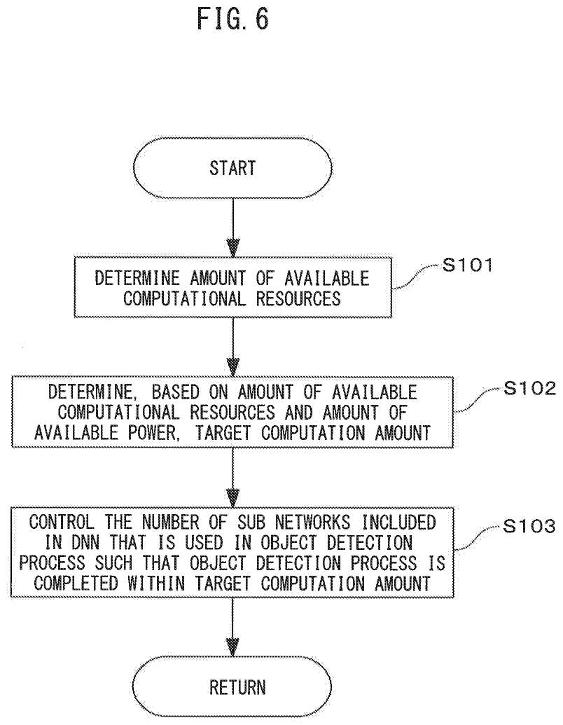

FIG. 6 is an operation flowchart of a classifier control process executed by the classifier control unit 33. The resource amount calculation unit 31, the target computation amount calculation unit 32, and the classifier control unit 33 execute, at every predetermined period (for example, 1/10 seconds to 1 second, or the like), the classifier control process in accordance with the operation flowchart illustrated in FIG. 6.

The resource amount calculation unit 31 of the processor 23 calculates, on the basis of an operation status of the processor 23, the amount of computational resources available for the object detection process using a :DNN, executed by the object detection unit 34 (step S101). The target computation amount calculation unit 32 of the processor 23 then calculates, on the basis of the amount of computational resources and the amount of power available for the object detection process using the DNN, the target computation amount (step S102).

The classifier control unit 33 of the processor 23 controls the number of sub networks which are used in the object detection process, among the plurality of sub networks included in the DNN that is used for object detection by the object detection unit 34 as the classifier in such a way that the object detection process may be completed within the target computation amount (step S103). After step S103, the classifier control unit 33 ends the classifier control process,

The object detection unit 34 is an example of a detection unit, and every time the object detection unit 34 obtains an image from the camera 2, the object detection unit 34 detects, by inputting the image to the DNN used as the classifier, the object to be detected existing around the vehicle 10, which is represented on the image. In the process, among the plurality of sub networks included in the DNN, each sub network controlled to be used in the object detection process by the classifier control unit 33 is used. Note that the object to be detected include a moving object such as ears or human beings. In addition, the object to be detected may further includes a stationary object, for example, road markings such as lane markings or road signs or traffic lights.

The object detection unit 34 outputs information indicating a type and a position on the image of the detected object to the driving planning unit 35.

The driving planning unit 35 generates, on the basis of the object detected in each image, one or more trajectories to be traveled for the vehicle 10 in such a way that the object existing around the vehicle 10 and the vehicle 10 do not collide. The trajectory to be traveled is represented, for example, as a set of target positions for the vehicle 10 at each time from the current time to a certain time later. For example, every time the driving planning unit 35 receives an image from the camera 2, the driving planning unit 35 transforms, by executing a viewing transformation process using information on the camera 2 such as the mounting position of the camera 2 in the vehicle 10, the received image into a bird's eye image. The driving planning unit 35 then tracks the object detected in each image by executing a tracking process on a series of bird's eye images using the Kalman filter or the like, and estimates, on the basis of the path obtained from the tracking result, an estimated trajectory for each object up to a certain time later. The driving planning unit 35 generates, on the basis of the estimated trajectory for each object being tracked, a trajectory to be traveled for the vehicle 10 in such a way that, for any object being tracked, an estimated value of the distance between the object and the vehicle 10 is equal to or greater than a certain distance until a certain time later. In the process, the driving planning unit 35 may confirm, with reference to, for example, a current position of the vehicle 10 represented in positioning information acquired from a GPS receiver (not illustrated) installed in the vehicle 10 and map information stored in the memory 22, the number of lanes in which the vehicle 10 can travel. In addition, the driving planning unit 35 may generate the trajectory to be traveled in such a way that, when there are a plurality of lanes in which the vehicle 10 can travel, the vehicle 10 may change lanes in which the vehicle 10 travels. In the process, the driving planning unit 35 may determine, with reference to a position of the lane marking detected in the image, a positional relationship between the vehicle 10 and the lane in which the vehicle 10 is traveling or a target lane to which the vehicle 10 is going to change. In addition, when the traffic light detected in the image indicates stop, the driving planning unit 35 may set the trajectory to be traveled in such a way that causes the vehicle 10 to stop at a stop line for the traffic light.

Note that the driving planning unit 35 may generate a plurality of trajectories to be traveled. In this case, the driving planning unit 35 may select a route among the plurality of trajectories to be traveled in such a way that the sum of absolute values of accelerations of the vehicle 10 is minimum.

The driving planning unit 35 informs the vehicle control unit 36 of the generated trajectory to be traveled.

The vehicle control unit 36 controls respective units of the vehicle 10 in such a way that the vehicle 10 travels along the informed trajectory to be traveled. For example, the vehicle control unit 36 calculates an acceleration of the vehicle 10 in accordance with the informed trajectory to be traveled and a current vehicle speed of the vehicle 10 measured by a vehicle speed sensor (not illustrated), and sets an accelerator position or a brake pedal position to achieve the acceleration. The vehicle control unit 36 then calculates an amount of fuel consumption in accordance with the set accelerator position, and outputs a control signal corresponding to the amount of fuel consumption to a fuel injection device of an engine of the vehicle 10. Alternatively, the vehicle control unit 36 outputs a control signal corresponding to the set brake pedal position to a brake of the vehicle 10.

The vehicle control unit 36 further calculates, when the vehicle 10 changes its course in order to travel along the trajectory to be traveled, a steering angle for the vehicle 10 in accordance with the trajectory to be traveled, and outputs a control signal corresponding to the steering angle to an actuator (not illustrated) that controls a steering wheel of the vehicle 10.

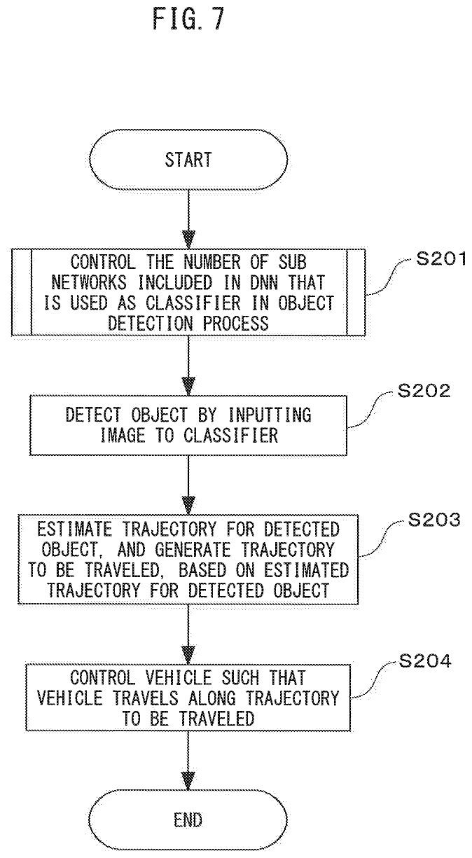

FIG. 7 is an operation flowchart of the vehicle control process that includes the object detection process, executed by the processor 23. Every time the processor 23 receives an image from the camera 2, the processor 23 executes the vehicle control process in accordance with the operation flowchart illustrated in FIG. 7. Note that, in the operation flowchart illustrated below, processing steps from step S201 to step S202 correspond to the object detection process.

The resource amount calculation unit 31, the target computation amount calculation unit 32, and the classifier control unit 33 of the processor 23 control, in accordance with the flowchart illustrated in FIG. 6, the number of sub networks, among the plurality of sub networks included in the variable layer of the DNN used as the classifier, which are used in the object detection process in such a way that the object detection process may be completed within the target computation amount determined in accordance with the amount of available computational resources and the amount of available power (step S201). In other words, as illustrated in FIG. 4 and FIG. 5, the classifier control unit 33 turns on the switch corresponding to the sub network corresponding to the target computation amount, and controls the classifier in such a way that the sub network is used for object detection. Then, the object detection unit 34 of the processor 23 inputs the image acquired from the camera 2 to the classifier to detect an object around the vehicle 10 represented in the image (step S202).

The driving planning unit 35 of the processor 23 tracks the detected object, and generates a trajectory to be traveled for the vehicle 10 in such a way that the trajectory to be traveled is separated from the estimated trajectory for the object obtained on the basis of the tracking result by a certain distance or more (step S203). Then, the vehicle control unit 36 of the processor 23 controls the vehicle 10 in such a way that the vehicle 10 travels along the trajectory to be traveled (step S204). Then, the processor 23 ends the vehicle control process.

As explained above, the object detection device controls the number of sub networks. Which are used in the object detection process among the plurality of sub networks included in the variable layer of the neural network used as the classifier in the object detection process in such a way that the object detection process executed on the image may be completed within the target computation amount corresponding to the target time. In this manner, the object detection device can complete the object detection process within the target time even when the amount of available computational resources and the amount of available power for the object detection process are limited. In addition, since each sub network has been learned in advance in accordance with the target computation amount in a state in which it is connected to the neural network, even when the amount of available computational resources and the amount of available power for the object detection process are limited, the object detection device may suppress deterioration of accuracy in object detection. Furthermore, when the total amount of available computational resources or the maximum value of the amount of available power for the object detection process is reduced, such as when part of the circuit of the processor 23 fails to operate properly or when an amount of power that can be supplied from the on-board battery decreases, the object detection device can reduce the computation amount required for the object detection process; therefore, the object detection device can complete the object detection process within the target time. At the same time, in the object detection device, a margin for a size of the DNN at the design stage is not necessary; therefore, when the amount of available computational resources and the amount of available power for the object detection process are sufficient, the object detection device can improve accuracy in object detection by using all of the sub networks in the object detection process.

According to a variation, the target computation amount calculation unit 32 may determine, on the basis of either one of the amount of computational resources available for the object detection process and the amount of power available for the object detection process, the target computation amount. For example, when the target computation amount is determined on the basis of the amount of computational resources available for the object detection process, the target computation amount calculation unit 32 may determine, with reference to the reference table indicating the relationship between the amount of computational resources available for the object detection process and the executable computation amount, which has been stored in the memory 22 in advance, the executable computation amount corresponding to the amount of available computational resources. Then, the target computation amount calculation unit 32 may determine, on the basis of the executable computation amount, the target computation amount in a similar fashion to the embodiments described above. In this case, the electric power sensor 3 may be omitted. In addition, when the target computation amount is determined on the basis of the amount of power available for the object detection process, the target computation amount calculation unit 32 may determine, with reference to the reference table indicating the relationship between the amount of power and the executable computation amount, which has been stored in the memory 22 in advance, the executable computation amount corresponding to the amount of power available for the object detection process. Then the target computation amount calculation unit 32 may determine, on the basis of the executable computation amount, the target computation amount in a similar fashion to the embodiments described above. In this case, the resource amount calculation unit 31 may be omitted.

According to another variation, the classifier control unit 33 may directly determine, on the basis of at least one of the amount of computational resources available for the object detection process and the amount of power available for the object detection process, the number of sub networks which are used in the object detection process among the plurality of sub networks included in the DNN. In this case, the classifier control unit 33 may determine a combination of switches to be turned on, which corresponds to the at least either one of the amount of computational resources available for the object detection process and the amount of power available for the object detection process, with reference to a reference table indicating a relationship between a combination of or at least either one of the amount of computational resources available for the object detection process and the amount of power available for the object detection process and the combination of switches to be turned on. In this case, the target computation amount calculation unit 32 may be omitted.

The object detection device according to the embodiments or the variations described above may be applied to a sensor signal acquired by a sensor other than the camera 2 for detecting an object existing around the vehicle 10. As such a sensor for detecting an object present in a predetermined detection range, for example, a LIDAR sensor or a laser sensor installed in the vehicle 10 may be used. In this case, the DNN used by the object detection unit 34 as the classifier may be learned in advance in such a way as to detect the object by means of the sensor signal acquired by the sensor installed in the vehicle 10. In this case, similarly to the embodiments or the variations described above, the classifier may also include one or more variable layers including a plurality of sub networks, and the plurality of sub networks may be learned in advance according to the target computation amount.

According to still another variation, the DNN that includes a plurality of sub networks may be used in a process other than the object detection process. For example, in order for the driving planning unit 35 to determine, on the basis of the position of the object which has been detected in a series of images and is tracked, a trajectory to be traveled for the vehicle 10, the DNN may be used. In this case, the ECU 4 is an example of the vehicle controller, the driving planning unit 35 is an example of the control information determination unit, and the trajectory to be traveled for the Vehicle 10 is an example of the control information for the vehicle 10. When the position detected from each image of the object being tracked is input, the DNN may be learned in advance, for example by means of a reinforcement learning technique, in such a way as to output an optimum trajectory to be traveled for the vehicle 10. In this case, the classifier control unit 33 may also determine, with reference to the reference table indicating a relationship between the available resources (at least one of the amount of computational resources and the amount of power) for the driving planning process executed by the driving planning unit 35 and the combination of switches to be turned on and on the basis of the resources, the sub network used in the driving planning process, among the plurality of sub networks included in the DNN. Note that, in this case, the reference table may also be configured in such a way that, as there are more resources available for the driving planning process, the number of sub networks used in the driving planning process increases. In this manner, even when the resources available for the driving planning process are limited, the driving planning unit 35 can complete a single driving planning process in a predetermined control cycle.

Furthermore, a computer program for achieving functions of respective units of the processor 23 of the object detection device according to the embodiments or the variations described above may be provided in a form recorded in a computer-readable portable recording medium such as a semiconductor memory, a magnetic recording medium, or an optical recording medium.

As described above, those skilled in the art may make various modifications according to embodiments within the scope of the present invention.

What is claimed is:

1. An object detection device comprising:
a processor configured to:
detect, by inputting a sensor signal acquired by a sensor installed in a vehicle to a neural network, an object existing around the vehicle, wherein the neural network includes an input layer to which the sensor signal is input, an output layer that outputs a result of detection of the object, and a plurality of layers connected between the input layer and the output layer, and wherein at least one layer of the plurality of layers includes a plurality of sub networks that includes the same structure and execute arithmetic processing in parallel to each other on a signal input to the layer; and
control, depending on at least either of an amount of power available for detection of the object or computational resources available for detection of the object, the number of sub networks which are used when the processor detects the object among the plurality of sub networks in each of the at least one layer.

2. The object detection device according to claim 1, wherein the processor calculates, depending on at least either of the amount of power available for detection of the object or the computational resources available for detection of the object, a target computation amount for detection of the object by the processor, and controls, based on the target computation amount, the number of sub networks, among the plurality of sub networks in each of the at least one layer, which are used when the processor detects the object.

3. The object detection device according to claim 2, further comprising:
a memory configured to store a table indicating a relationship between the target computation amount and a sub network, for each of the at least one layer, which is used when the processor detects the object, among the plurality of sub networks, and
wherein the processor determines for each of the at least one layer of the neural network, with reference to the table and based on the target computation amount, a sub network used when the processor detects the object, among the plurality of sub networks.

4. An object detection method comprising:
detecting, by inputting a sensor signal acquired by a sensor installed in a vehicle to a neural network, an object existing around the vehicle, wherein the neural network includes an input layer to which the sensor signal is input, an output layer that outputs a result of detection of the object, and a plurality of layers connected between the input layer and the output layer, and wherein at least one layer of the plurality of layers includes a plurality of sub networks that includes the same structure and execute arithmetic processing in parallel to each other on a signal input to the layer; and
controlling, depending on at least either of an amount of power available for detection of the object or computational resources available for detection of the object, the number of sub networks which are used when detecting the object among the plurality of sub networks in each of the at least one layer.

5. A vehicle controller comprising:
a processor configured to:
determine control information for a vehicle, by inputting information indicating a position of an object around the vehicle to a neural network, the position being detected by means of a sensor signal acquired by a sensor installed in the vehicle, wherein the neural network includes an input layer to which the information indicating the position of the object around the vehicle is input, an output layer that outputs the control information, and a plurality of layers connected between the input layer and the output layer, and wherein at least one layer of the plurality of layers includes a plurality of sub networks that include the same structure and execute arithmetic processing in parallel to each other on a signal input to the layer; and
control, depending on at least either of an amount of power available for determination of the control information or computational resources available for determination of the control information, the number of sub networks which are used when the processor determines the control information among the plurality of sub networks in each of the at least one layer.
